(19) United States
(12) Patent Application Publication
(10) Pub. No.: US 2023/0162500 A1
(43) Pub. Date: May 25, 2023

(54) INFORMATION PROCESSING DEVICE, INFORMATION PROCESSING PROGRAM AND INFORMATION PROCESSING METHOD

(71) Applicant: OrangeTechLab Inc., Tokyo (JP)

(72) Inventors: Kenji NISHIDA, Tokyo (JP); Toshiya YAMADA, Tokyo (JP); Ichiro YAMASHITA, Tokyo (JP); Jun MIYAZAKI, Tokyo (JP)

(21) Appl. No.: 17/903,058

(22) Filed: Sep. 6, 2022

(30) Foreign Application Priority Data
Nov. 19, 2021 (JP) 2021-188978

(51) Int. Cl. G06V 20/40

(52) U.S. Cl. CPC G06V 20/46

(57) ABSTRACT

The present invention provides an information processing device capable of analyzing a time-series correlation in the motions of a plurality of objects without being limited to specific purpose and object. In the information processing device, a first analysis unit is configured to analyze a first motion of a first object, a second analysis unit is configured to analyze a second motion of a second object, and a correlation analysis unit is configured to analyze a time-series correlation between the first motion analyzed by the first analysis unit and the second motion analyzed by the second analysis unit.

### CROSS-REFERENCES TO RELATED APPLICATIONS

This patent specification is based on Japanese patent application, No. 2021-188978 filed on Nov. 19, 2021 in the Japan Patent Office, the entire contents of which are incorporated by reference herein.

### BACKGROUND OF THE INVENTION

### 1. Field of the Invention

The present invention relates to an information processing device, an information processing program and an information processing method. In particular, the present invention relates to the information processing for analyzing a correlation of the motions between a plurality of objects (e.g., between human and human and between human and a device such as an automobile).

### 2. Description of Related Art

The following technologies are known as the technology related to an interaction analysis.

In order to analyze the interaction (e.g., human conversation) between a plurality of objects, it is necessary to obtain the correlation between the actions of the object (Non-patent Document 1). In addition, the method of quantitatively analyzing the interaction is not necessarily established (Non-patent Document 2).

The following technology is known as the technology related to a higher-order local auto-correlation feature.

Regarding the feature quantity used for the image analysis and the like, Higher-order Local Auto-Correlation: HLAC feature has been established as a patent (HLAC feature quantity extracting method and failure detecting method, Patent Document 1). Furthermore, Cubic Higher-order Local Auto-Correlation (CHLAC) feature (Patent Document 3) where HLAC is expanded to the three dimension and Motion Index Cubic Higher-order Local Auto-Correlation (MICHLAC) feature (Patent Document 4) where the mutual correlation is obtained in deferent feature quantities are also proposed. In the above described feature quantities, the curvature in the image can be extracted as feature quantities by extracting three neighboring pixels (extracting pixels from totally nine pixels of 3×3 in HLAC, (extracting three pixels from totally twenty seven pixels of 3×3×3 in CHLAC and MCHLAC) and obtaining the correlation.

In the higher-order local auto-correlation group, the correlation (autocorrelation) is extracted in a single object and does not extract the correlation in a plurality of objects. Although MICHLAC is characterized in that the “mutual” correlation is achieved by obtaining the correlation in a plurality of feature quantities, the correlation is still extracted in a single object.

Patent Document 1: Japanese Patent No. 5131863

[Non-patent Document 1] N J Enfield, J. Sidnell, “On the concept of action in the study of interaction”, Discourse Studies, Vol. 19, No. 5, 2017, https://journals.sagepub.com/doi/abs/10.1177/1461445617730235

[Non-patent Document 2] D. W. Putwain, R. Rekrun, at al. “Control-Value Appraisals, Enjoyment, and Boredom in Mathematics: A Longitudinal Latent Interaction Analysis”, American Educational Research Journal, Vol.55, No.6, 2018, https://journals.sagepub.com/doi/abs/10.3102/0002831218786689

[Non-patent Document 3] T. Kobayashi, N. Otsu, “Action and simultaneous multiple-person identification using cubic higher-order local auto-correlation”, https://ieeexplore.ieee.org/abstract/document/1333879?casa_token=4ue6I_InhOsAAAA A:465VU2x9gIQfP4zDu4jTQWG_FmkDsrFEYrj QoMYkeiAyZlR3Kg0sKUxZCKjCTP cG8ZwNsp-v9Sc

[Non-patent Document 4] T. Matsukawa, T. Kurita, “Action Recognition Using Three-Way Cross-Correlations Feature of Local Motion Attributes”, International Conference on Pattern Recognition 2010, https://ieeexplore.ieee.org/abstract/document/5597474?casa_token=G0x19AZsc6YAAAA A:2B728VrEd4IvrRwYFIw0EV6GswG3bRhzPQM12zKxAYquFMXc0B2QGCxiUB-9Qe2LmjPvIMmPxM

### BRIEF SUMMARY OF THE INVENTION

There is no conventional method for generally and quantitatively analyzing the mutual interaction (abstraction in layers) between human and human and between human and an object. The conventional technology depends on a specific method for solving the specific purpose. Thus, there is no versatility. Namely, in the conventional technology, it is necessary to change the configuration each time when the purpose and the object are changed. Therefore, expandability is poor and it is difficult to be used generally.

The present invention aims for providing an information processing device, an information processing program and an information processing method capable of analyzing a time-series correlation in the motions of a plurality of objects without being limited to specific purpose and object.

In order to achieve the above described purpose, summary of the present invention is as follows.

The invention [1] is an information processing device including: a first analysis unit configured to analyze a first motion of a first object from a time-series data; a second analysis unit configured to analyze a second motion of a second object from the time-series data; and a correlation analysis unit configured to analyze a time-series correlation between the first motion analyzed by the first analysis unit and the second motion analyzed by the second analysis unit.

The invention [2] is the information processing device according to the invention [1], wherein one frame is formed by one unit of a motion, and when the time-series correlation is analyzed, the processor is configured to analyze a correlation between the first motion and the second motion in frames neighboring to each other in time series.

The invention [3] is the information processing device according to the invention [2], wherein when the time-series correlation is analyzed, the processor is configured to further analyze the correlation between the first motion and the second motion in one frame simultaneously performed.

The invention [4] is the information processing device according to the invention [3], wherein when the time-series correlation is analyzed, the processor is configured to analyze the time-series correlation by counting a part matched with a mask pattern formed by one frame.

The invention [5] is the information processing device according to the invention [2], wherein when the time-series correlation is analyzed, the processor is configured to analyze the time-series correlation between the first motion and the second motion performed in continuous frames.

The invention [6] is the information processing device according to the invention [5], wherein when the time-series correlation is analyzed, the processor is configured to analyze the time-series correlation by counting a part matched with a mask pattern formed by two or more continuous frames.

The invention [7] is the information processing device according to the invention [4] or [6], wherein when the time-series correlation is analyzed, the processor is configured to analyze the time-series correlation by generating a histogram from a counting result obtained by counting the part matched with the mask pattern.

The invention [8] is the information processing device according to the invention [7], wherein the processor is configured to perform a mechanical leaning using the histogram as a teacher data of the mechanical leaning.

The invention [9] is an information processing program for making a computer function as: a first analysis unit configured to analyze a first motion of a first object from a time-series data; a second analysis unit configured to analyze a second motion of a second object from the time-series data; and a correlation analysis unit configured to analyze a time-series correlation between the first motion analyzed by the first analysis unit and the second motion analyzed by the second analysis unit.

The invention [10] is an information processing method performed by an information processing device, the method including: a first step for analyzing a first motion of a first object from a time-series data; a second step for analyzing a second motion of a second object from the time-series data; and a third step of analyzing a time-series correlation between the first motion analyzed in the first step and the second motion analyzed in the second step.

In the information processing device of the invention [1], the time-series correlation can be analyzed in the motions of a plurality of objects without being limited to specific purpose and object.

In the information processing device of the invention [2], the correlation can be analyzed between the first motion and the second motion in frames neighboring to each other in time series.

In the information processing device of the invention [3], the correlation can be further analyzed between the first motion and the second motion in one frame simultaneously performed.

In the information processing device of the invention [4], the correlation can be analyzed by counting a part matched with a mask pattern formed by one frame.

In the information processing device of the invention [5], the correlation can be analyzed between the first motion and the second motion performed in continuous frames.

In the information processing device of the invention [6], the correlation can be analyzed by counting a part matched with a mask pattern formed by two or more continuous frames.

In the information processing device of the invention [7], the correlation can be analyzed by generating a histogram from a counting result obtained by counting the part matched with the mask pattern.

In the information processing device of the invention [8], a mechanical leaning can be performed using the histogram as a teacher data of the mechanical leaning.

In the information processing program of the invention [9], the time-series correlation can be analyzed in the motions of a plurality of objects without being limited to specific purpose and object.

In the information processing method of the invention [10], the time-series correlation can be analyzed in the motions of a plurality of objects without being limited to specific purpose and object.

### BRIEF DESCRIPTION OF THE DRAWINGS

FIG. 1 is a module configuration diagram conceptually showing an example of a configuration example of the present embodiment.

FIGS. 2A and 2B are explanatory drawings showing a system configuration example using the present embodiment.

FIG. 3 is a flow chart showing a processing example of the present embodiment.

FIG. 4 is an explanatory drawing showing a processing example of the present embodiment.

FIG. 5 is an explanatory drawing showing a processing example of the present embodiment.

FIG. 6 is an explanatory drawing showing a processing example of the present embodiment.

FIG. 7 is an explanatory drawing showing a processing example of the present embodiment.

FIGS. 8A to 8C are explanatory drawings showing a processing example of the present embodiment.

FIGS. 9A to 9C are explanatory drawings showing a processing example of the present embodiment.

FIGS. 10A and 10B are explanatory drawings showing a processing example of the present embodiment.

FIGS. 11A and 11B are explanatory drawings showing a processing example of the present embodiment.

FIGS. 12A to 12D are explanatory drawings showing a processing example of the present embodiment.

FIGS. 13A and 13B are explanatory drawings showing a processing example of the present embodiment.

FIGS. 14A and 14B are explanatory drawings showing a processing example of the present embodiment.

FIG. 15 is a block diagram showing a hardware configuration example of a computer achieving the present embodiment.

### DETAILED DESCRIPTION OF THE INVENTION

Hereafter, an example of an embodiment suitable for achieving the present invention will be explained based on the drawings.

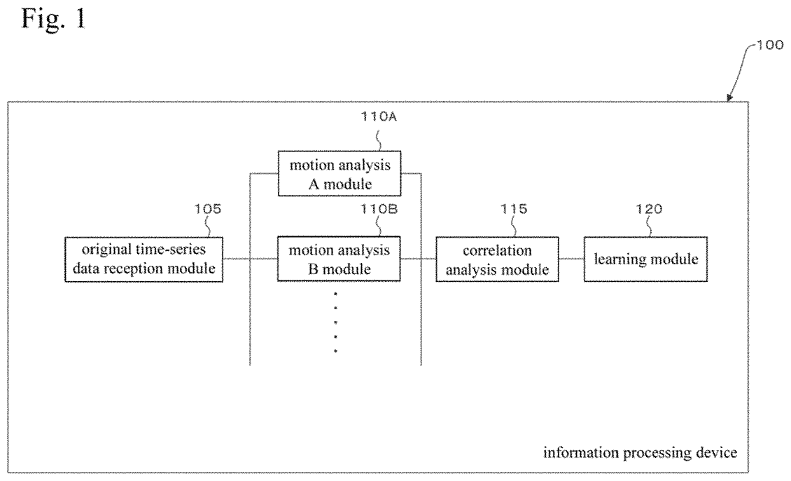

FIG. 1 is a module configuration diagram conceptually showing a module configuration example of the present embodiment.

Note that the module indicates generally and logically separatable components such as a software (including computer program as an interpretation of the software) and a hardware. Accordingly, the module in the preset embodiment includes not only the module in the computer program but also the module in the hardware configuration. Therefore, the present embodiment also explains a computer program (e.g., a program for making the computer execute a procedure, a program for making the computer function as a means, a program for making the computer achieve a function), a system and a method for making the component function as the module. For the convenience of the explanation, when the term of “store” and similar terms are used in the embodiment of the computer program, these terms mean to store in a storage device or to control to be stored in the storage device. The module and the function can correspond to each other by one to one. In an implementation, one module can be formed by one program, a plurality of modules can be formed by one program and one module can be formed by a plurality of programs. In addition, a plurality of modules can be executed by one computer and one module can be executed by a plurality of computers in a distributed environment or a parallel environment. Note that one module can include other modules. Hereafter, “connection” is used for the physical connection and logical connection (e.g., data exchange, instruction, reference relationship between the data and login). “Preliminarily determined” means that something has determined before the target process. Of course, “preliminarily determined” includes the timing before the processing of the present embodiment is started. Even after the processing of the present embodiment is started, when the target processing is not started, “preliminarily determined” is used as the meaning of “determined in accordance with the current situation and state” or “determined in accordance with the past situation and state.” When a plurality of “preliminarily determined values” exists, the values can be different from each other or two or more values can be the same. Needless to say, two or more values include all values. The description “when A, do B” means “whether or not A is judged and then do B if judged to A.” However, this excludes the case where the judgement whether or not A is not required. When the items are listed such as “A, B and C,” the items are listed merely as examples unless otherwise indicated. Thus, the configuration having only one (e.g., only A) of the listed items is included.

A system or a device includes the configuration where a plurality of computers, hardware, devices and the like are connected with each other via a communication means such as network (“network” includes one-to-one correspondence communication connection). In addition, the system or the device also includes the configuration achieved by one computer, hardware or device. The terms of “device” and “system” are used synonymous with each other. Needless to say, “system” does not include a mere social “structure” (i.e., social system) which is an artificial arrangement (human decision).

The target information is read from a storage device and the processing result is written to the storage device after the processing is finished each time when the processing is performed by each module or each time when the processing is performed by the module even when a plurality of processing is performed in the module. Accordingly, the explanation of the reading operation from the storage device before the processing and the writing operation to the storage device after the processing may be omitted.

Needless to say, it can be considered that “problems to be solved by the invention” are to provide an object (e.g., device), a method and a program concerning the embodiments explained below or to provide an object (e.g., device), a method and a program concerning the invention grasped by the embodiments.

An information processing device 100, which is an embodiment of the present invention, has a function of performing a processing of analyzing a correlation of motions between a plurality of objects. As shown in the example of FIG. 1, the information processing device 100 includes an original time-series data reception module 105, a motion analysis A module 110A, a motion analysis B module 110B, a correlation analysis module 115 and a learning module 120.

Here, “motion of object” will be explained.

The “object” includes living things (e.g., animals, plants) including human and inanimate objects such as an automobile. Accordingly, the concrete examples of the combination of two objects can be human and human, human and animal (e.g., dog), animal and animal, human and machine (e.g., automobile, robot), animal and machine or machine and machine, as a concrete example. More specifically, as for the situation to be analyzed in the present embodiment, the following situations can be considered. As an example of human and human, the motion of a teacher and the motion of a student are analyzed in a situation of a seminar. As an example of human and animal, the motion of a trainer and the motion of a dog are analyzed in a situation of an animal training (dog training). As an example of human and plant, the motion of a farmer and a growth of a vegetable are analyzed in a situation of a cultivation. As an example of animal and animal, the motions of sheep in a farm are analyzed in a situation of management of sheep. As an example of human and automobile, the motion of the driver and the motion of an oncoming car are analyzed in a situation of a driving. As an example of animal and machine, the motion of a cow and the motion of a milking machine are analyzed in a situation of milking. As an example of automobile and automobile, a flow of automobiles in an intersection and road rage are analyzed.

Furthermore, the “object” can be a part of the living things and the inanimate objects. Accordingly, as the combination of two objects, the combination of a face (one object) of one person and a hand (the other object) of the same person or the combination of a hand and a mouth of the same person can be considered, for example. More specifically, as for the situation to be analyzed in the present embodiment, the following situations can be considered. As an example of the motion of the hand and the motion of the face of the same person, a gesture can be analyzed. As an example of the motion of the hand and the motion of the mouth of the same person, a sign language can be analyzed. The cooperation between the motion of the hand and the motion of the mouth is important since some hearing-impaired people also refer to the motion of the mouth for communication. Needless to say, in addition to the combination of a part of the living things and a part of the living things, the combination of a part of the inanimate objects and a part of the inanimate objects or the combination of a part of the living things and a part of the inanimate objects can be also analyzed.

In addition, the combination of the object can be the combination of a whole and a part of the object. For example, the combination of a face of a driver and an oncoming car can be considered. More specifically, as for the situation to be analyzed in the present embodiment, the motion of the face of the driver and the motion of the oncoming car are analyzed in the situation of the driving, for example.

Although the combination of two objects is exemplified above, the combination of three or more objects is also possible.

The “motion” is the change of the object in time series. As an example of the “motion,” an action of the human can be listed. As for the human action detected from an image, the motion of large components (e.g., hand, finger, face, leg) of the human or the motion of small components (e.g., mouth, eye) of the human can be listed. Furthermore, subtle motion such as a motion of a glance (e.g., so-called “shifty eyes”) can be included. When the motion is subtle, it is also possible to emphasize the motion and then detect it. Specifically, when the object is the human, the “motion” includes a movement, an action, a manner, a behavior, a gesture, an attitude, a sign, a body language, a hand gesture, a performance and the like. Other than above, the “motion” can be a sound. In addition to the motion detected from the outer surface of the object, the motion of inside the object can be included. Specifically, the change in a biological information of the human such as blood pressure, blood flow, heart rate, arterial oxygen saturation and the like can be included in the “motion.”

Furthermore, unconscious motion can be included in the motion in addition to conscious motion. As the conscious motion, pointing with a finger, walking and the like can be listed, for example. As the unconscious motion, change of the size of pupil, change of the heart rate and the like can be listed, for example.

The recorded data of the “motion” is an image (moving image) data photographed by a camera, a sound data collected by a microphone and a data collected by various sensors, for example. The sensors can be measuring instruments such as a blood pressure gauge where a user is conscious of being measured or wearable sensors such as an acceleration sensor and a gyro sensor where the user is almost unconscious of being measured. Needless to say, when the “motion” is recorded by the camera or the microphone, it is not necessary to preliminarily install the sensor in the object. Namely, the image (recorded image) can be analyzed afterward even when the image is recorded without considering to analyze the correlation of the present embodiment in advance.

The information processing device 100 is an interaction evaluation device in a plurality of objects. The higher order local cross-correlation feature is used for the interaction analysis. The higher order local cross-correlation feature is named HLBC2 (Higher Order Local Cross-Correlation).

The information processing device 100 performs the following processing. The motion of the object of the interaction analysis is detected as a discretized behavior time series (one unit of the discretized behavior is called as a frame) and extracts the correlation between a plurality of (two or more) neighboring behavior time series. The correlation is extracted from not only the neighboring two frames but also three frames. Namely, the higher order correlation is extracted as feature quantity.

In HLAC (Higher-order Local Auto-Correlation) and the like, the correlation is extracted in a single object. On the other hand, in the present embodiment, the correlation is extracted in time series of a plurality of (two or more) motions.

In the present embodiment, the local correlation is extracted from the abstracted “motion” without using image feature. This is the method not disclosed in the prior arts.

For example, three frames are extracted from three neighboring frames (totally six frames) neighbored in time series in the motion of two objects. Thus, the higher order local cross-correlation is extracted.

The original time-series data reception module 105 is connected with a motion analysis module 110 to receive original time-series data which indicates the motion of the object. The original time-series data can be any data which records the motion of the object. For example, the original time-series data can be moving image data, sound data and a time-series data of biological information such as blood pressure.

To receive the original time-series data means to generate the original time-series data or to input the generated original time-series data. Namely, the original time-series data reception module 105 can include devices (camera, microphone, various sensors) of generating the original time-series data and the original time-series data reception module 105 can be an input interface of these devices. The processing of the original time-series data reception module 105 includes the operation of photographing the moving image by the camera, the operation of reading the moving image data photographed by the camera, the operation of collecting sound data by a microphone, the operation of reading the sound data collected by the microphone, the operation of receiving the original time-series data from an external device via a communication line and the operation of reading the original time-series data stored in a hard disk and the like (incorporated in a computer and connected via a network), for example.

The motion analysis module 110 is connected with the original time-series data reception module 105 and the correlation analysis module 115 to analyze the motion of the object. For analyzing the motions of at least two objects, at least the motion analysis A module 110A and the motion analysis B module 110B are provided. The motion analysis A module 110A analyzes a first motion of a first object using the original time-series data received by the original time-series data reception module 105 and transmits the analysis result to the correlation analysis module 115. The motion analysis B module 110B analyzes a second motion of a second object using the original time-series data received by the original time-series data reception module 105 and transmits the analysis result to the correlation analysis module 115. The analysis result is also referred to as “motion time-series data” or “action time-series data” when more specifically explained.

When analyzing the motions of three or more objects, it is possible to add the motion analysis module 110 in accordance with the number of the objects. Specifically, a motion analysis C module 110C for analyzing the motion of the third object and a motion analysis D module 110D for analyzing the motion of the fourth object can be added, for example.

Furthermore, it is also possible to analyze the motions of a plurality of objects by one motion analysis module 110. In that case, instead of parallelly performing the processing by the motion analysis A module 110A and the motion analysis B module 110B, one of the motion analysis modules 110 analyzes the first motion of the first object and then analyzes the second motion of the second object sequentially. However, even in the above described case, the motion analysis module 110 is the motion analysis A module 110A when the first motion of the first object is analyzed and the motion analysis module 110 is the motion analysis B module 110B when the second motion of the second object is analyzed.

The analysis performed by the motion analysis module 110 identifies the motion of the object. For example, when the moving image of a seminar of two persons (teacher and student) is analyzed, the motion of each person is identified to any one of: (1) to turn face to the other person; (2) to turn face to document; (3) to nod; and (4) to speak. As a concrete processing example, as described later, a three dimensional human model having a joint and other components is used and a preliminarily determined motion is recognized from the motions of the components.

The correlation analysis module 115 is connected with the motion analysis A module 110A, the motion analysis B module 110B and the learning module 120 to analyze a time-series cross-correlation between the first motion analyzed by the motion analysis A module 110A and the second motion analyzed by the motion analysis B module 110B.

Here, one frame can be formed by one unit of the motion. In that case, the correlation analysis module 115 analyzes the correlation between the first motion (analysis result of the motion analysis A module 110A) and the second motion (analysis result of the motion analysis B module 110B) in frames neighboring to each other in time series.

Furthermore, the correlation analysis module 115 can analyze the correlation between the first motion and the second motion in one frame simultaneously performed.

More specifically, the correlation analysis module 115 can analyze the correlation by counting a part matched with a mask pattern formed by one frame. This corresponds to the analysis of the later described zero order correlation.

Furthermore, the correlation analysis module 115 can analyze the correlation between the first motion and the second motion performed in continuous frames.

Specifically, the correlation analysis module 115 can analyze the correlation by counting a part matched with a mask pattern formed by two or more continuous frames. This corresponds to the analysis of the later described first or higher order correlation.

More specifically, counting the part matched with the mask pattern formed by two frames corresponding to the analysis of the first order correlation and counting the part matched with the mask pattern formed by three frames corresponding to the analysis of the second order correlation.

Furthermore, the correlation analysis module 115 can analyze the correlation by generating a histogram from a counting result obtained by counting the part matched with the mask pattern. Namely, the histogram indicates the frequency that one pattern of the motion or a plurality of patterns of the motions appears. Note that the histogram is not necessarily displayed as a graph. The histogram can have any data structure as long as each mask pattern corresponds to the counting result of the mask pattern.

The learning module 120 is connected with the correlation analysis module 115 to perform a mechanical leaning using the histogram as a teacher data of the mechanical leaning. By using the model generated by the mechanical leaning, the situation formed by the motions can be evaluated from the motions of the similar objects.

For example, in the situation of the above described seminar, it is possible to execute questionnaire survey (e.g., questionnaire survey questioning the degree of understanding the seminar content) after the seminar to one of the subjects (the student side). Thus, it is possible to perform the mechanical leaning by associating the histogram with the result of the questionnaire survey. By the model generated by the mechanical leaning, the evaluation of the future seminar can be performed.

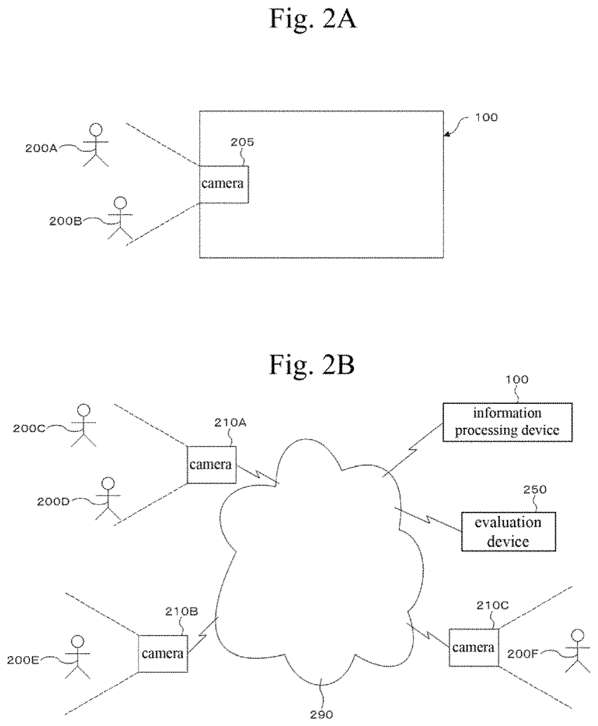

FIGS. 2A and 2B are explanatory drawings showing a system configuration example using the present embodiment.

FIG. 2A shows an example when the information processing device 100 is constructed as a stand-alone type system. The information processing device 100 has a camera 205 as the original time-series data reception module 105. The camera 205 photographs a person 200A and a person 200B. For example, in the situation of the above described seminar, the person 200A is a teacher and the person 200B is a student and the camera 205 photographs the scene where the seminar is conducted using the document.

The information processing device 100 analyzes the motion of the person 200A and the motion of the person 200B and analyzes the correlation between them. For example, the person 200A explains while looking at the face of the person 200B, and the person 200B nods and performs other motions while looking at the document. The person 200A looks at the response of the person 200B and makes further explanation, for example. Namely, the interaction is performed between the person 200A and the person 200B while affecting each other.

The motion analysis module 110 identifies the motion. Specifically, it is understood that the person 200A had the motion of ‘turning the face to the other person” and the motion of “speaking” and then the person 200B had the motion of “turning face to document” and the person 200B had the motion of “nodding” and the person 200A further had the motion of “speaking.” The correlation analysis module 115 counts the number of times of performing the above described series of motions. Other than the above described series of motions, different motions are continuously performed by different persons or different order.

After the seminar is finished, a questionnaire survey is executed to the person 200B. The evaluation such as the seminar was “very easy to understand” is obtained, for example. The number of times and evaluation of each of the series of the motions are associated with each other as the teacher data. Needless to say, the teacher data is generated by analyzing the scenes of a plurality of seminars. The learning module 120 performs the mechanical leaning using the teacher data. The evaluation in the other seminars is possible using the model formed by the mechanical leaning.

FIG. 2B shows an example when the information processing device 100 is constructed as a network type system. A camera 210A, a camera 210B and a camera 210C are connected with the information processing device 100 via a communication line 290. Note that the communication line 290 can be wired, wireless or the combination of them. For example, the communication line 290 can be internet, intranet or the like as a communication infrastructure. Furthermore, the functions of the information processing device 100 and the evaluation device 250 can be achieved as a cloud service.

The camera 210A photographs the motions of a person 200C and a person 200D and transmits the moving images to the information processing device 100. In the above described example of FIG. 2A, a remotely held seminar is analyzed as an example.

In addition, in some cases, a person 200E who is the teacher and a person 200F who is the student are at remote locations and the seminar is held online. In that case, it is possible to transmit the moving images to the information processing device 100 from both the camera 210B photographing the person 200E and the camera 210C photographing the person 200F. Furthermore, the information processing device 100 can acquire the moving images of the person 200E and the moving images of the person 200F via the web meeting system holding the online seminar. Same as the above described example of FIG. 2A, the teacher data is generated from the moving image of each seminar and the mechanical leaning is performed using the teacher data.

The information processing device 100 can construct the evaluation device 250 using the model generated by the mechanical leaning. The camera 210A, the camera 210B and the camera 210C are connected with the evaluation device 250 via the communication line 290.

Same as the information processing device 100, the evaluation device 250 acquires the moving image of the seminar joined by the person 200C and the person 200D from the camera 210A and evaluates the seminar. In addition, the evaluation device 250 acquires the moving image of the person 200E and the person 200F from the camera 210B and the camera 210C and evaluates the online seminar.

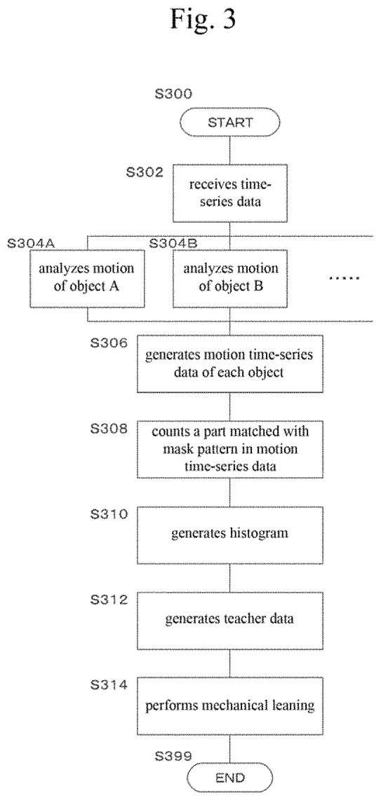

FIG. 3 is a flow chart showing a processing example of the present embodiment.

In Step S302, the original time-series data reception module 105 receives the time-series data to be analyzed. For example, the moving image of the seminar joined by the teacher and the student is received.

In Step S304A, the motion analysis A module 110A analyzes the motion of the object A in the time-series data received in Step S302. For example, the action of the teacher is identified.

In Step S304B, the motion analysis B module 110B analyzes the motion of the object B in the time-series data received in Step S302. For example, the action of the student is identified.

Note that the processing of Step S304 is performed by the number of the objects to be analyzed. Namely, when the number of the objects is three or more, the processing of Step S304 is performed three or more times.

In addition, a plurality of the processing of Step S304 can be parallelly performed or sequentially performed.

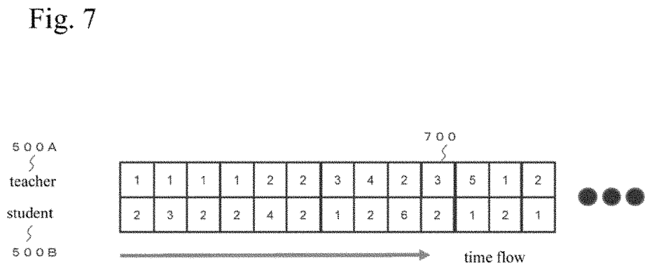

In Step S306, the correlation analysis module 115 generates the motion time-series data of each object using the processing result of Step S304. Specifically, an array where the values showing the movement of each object is arranged on the same time axis. For example, the action time-series data 700 illustrated in the later described FIG. 7 is generated.

In Step S308, a part matched with the mask pattern is counted in the motion time-series data. The mask pattern can cover all patterns that can happen or the mask pattern can be a selected pattern (predetermined pattern) selected from all patterns. Here, all patterns are generated by combining the objects, the motions of the objects and the order of the motions.

In Step S310, the correlation analysis module 115 generates the histogram. The histogram is, specifically, a graph showing the mask pattern in a horizontal axis and showing the number of times of appearing the mask pattern in the vertical axis.

In Step S312, the correlation analysis module 115 generates the teacher data for the mechanical leaning using the histogram generated in Step S310. As described above, the teacher data can be generated by associating the histogram data with the result of the questionnaire survey. Alternatively, the teacher data can be generated by associating only the selected histogram data with the result of the questionnaire survey. For example, the mask pattern whose number of the appearance is 0 in the histogram data can be eliminated or the mask pattern whose number of the appearance in the histogram data is extremely high can be also eliminated. The “extremely high number” can be defined as the preliminarily determined number or more or defined by using an average value, a standard deviation and the like of a parent population.

In Step S314, the learning module 120 performs the mechanical leaning using the teacher data generated in Step S312. Thus, the model for evaluating the scene where the object acts is generated. Needless to say, a plurality of teacher data is required.

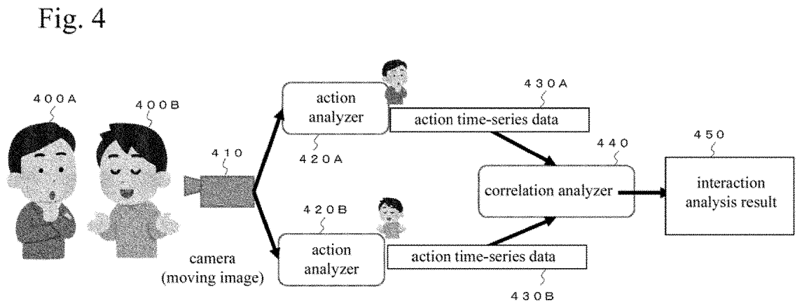

FIG. 4 is an explanatory drawing showing a processing example of the present embodiment.

A camera 410 is a concrete example of the original time-series data reception module 105, an action analyzer 420 is a concrete example of the motion analysis module 110, and a correlation analyzer 440 is a concrete example of the correlation analysis module 115.

A moving image of a conversation scene between a person 400A and a person 400B is photographed by the camera 410. Each of the action analyzer 420 detects an action time-series data 430 such as a conversation and a nod. The correlation analyzer 440 obtains the correlation between an action time-series data 430A and an action time-series data 430B (actions of the person 400A and the person 400B) in a behavior time series. Thus, the correlation analyzer 440 performs the interaction analysis between the two and outputs an interaction analysis result 450 as the processing result.

As the action analyzer 420, the technologies shown in the following documents can be used.

“Consideration of Machine Learning-based Action Recognition Methods using the OpenPose Keypoint Detection Library”

https://db-event.jpn.org/deim2019/post/papers/174.pdf

“Method for identifying conversation and micro operation from meeting image”

https://yukimat.jp/data/pdf/paper/DisCaaS_c_202003_soneda_ubi65.pdf

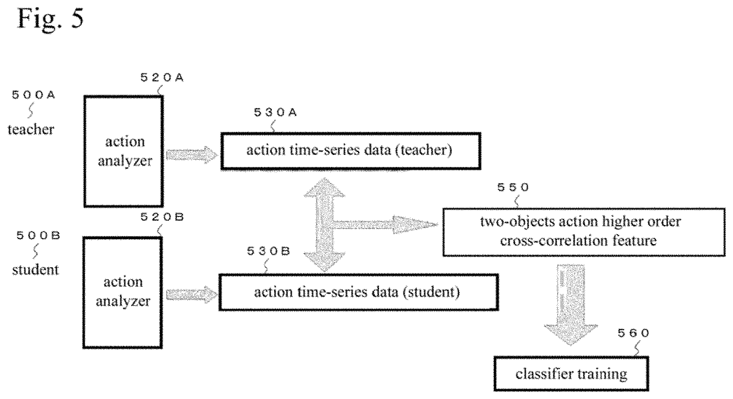

FIG. 5 is an explanatory drawing showing a processing example of the present embodiment.

A concrete example will be shown.

Based on the interaction between a teacher 500A and a student 500B, an evaluation (determination of superiority/inferiority) of a one-on-one seminar is performed as an example.

The action of the teacher 500A in the seminar is analyzed by an action analyzer 520A to generate an action time-series data (teacher) 530A and the action of the student 500B is analyzed by an action analyzer 520B to generate an action time-series data (student) 530B. A two-objects action higher order cross-correlation feature 550 (corresponding to the interaction analysis result 450 in the example of FIG. 4) is generated from the action time-series data (teacher) 530A and the action time-series data (student) 530B.

The above described processing will be explained more in detail.

The moving image photographing two objects (teacher 500A, student 500B) is analyzed by the action analyzer 520 and the action time-series data 530 (i.e., the action time-series data (teacher) 530A and the action time-series data (student) 530B) is obtained. From the action time-series data 530 of two objects, the following time relationship (correlation) is extracted as the two-objects action higher order cross-correlation feature 550:

(1) the motions simultaneously performed;

(2) the motions performed in two continuous frames; and

(3) the motions performed in three continuous frames.

A classifier training 560 is performed using the two-objects action higher order cross-correlation feature 550.

Namely, the original time-series data of the motion of the teacher 500A and the motion of the student 500B is analyzed and the interaction is quantified based on the time-based correlation. The model capable of evaluating whole the seminar is generated by performing the classifier training 560.

In the information processing device 100 of the present embodiment, the higher order cross-correlation feature is introduced when a time-series cross-correlation of a plurality of objects is obtained. Thus, a general interaction analysis is achieved.

In the following explanation, the cross-correlation of one frame (simultaneously), two frames (two continuous frames) and three frames (two continuous frames) is detected. Thus, wide variety of patterns of the interactions can be detected. Note that it is also possible to detect the pattern in four or more continuous frames.

Because of this, since the feature quantity is accumulated over a certain time period, the interaction during the accumulated period can be abstracted.

The explanation will be made more in detail.

The moving image photographing two objects (teacher 500A, student 500B) is analyzed by the action analyzer 520 and the action time-series data 530 (i.e., the action time-series data (teacher) 530A and the action time-series data (student) 530B) is obtained. From the action time-series data 530 of two objects, the following time relationship (correlation) is extracted as the two-objects action higher order cross-correlation feature 550:

(1) the motions simultaneously performed;

(2) the motions performed in two continuous frames; and

(3) the motions performed in three continuous frames.

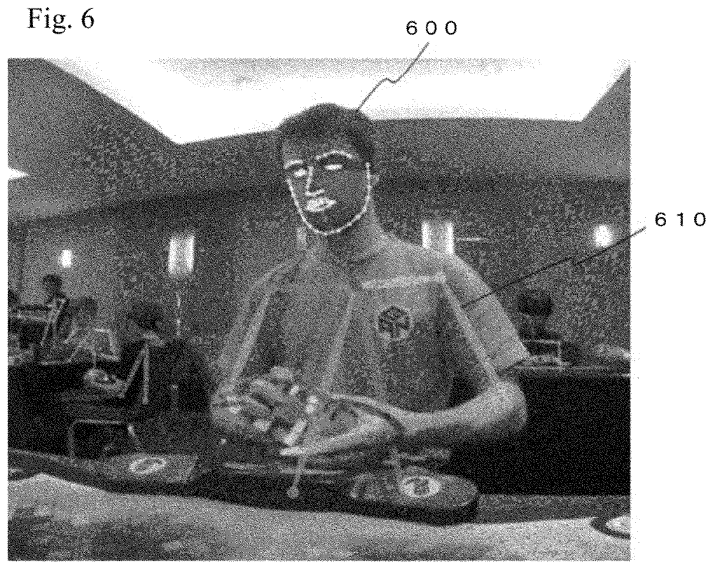

FIG. 6 is an explanatory drawing showing a processing example of the present embodiment.

The example of FIG. 6 shows a three dimensional human model having a joint and other components. A human 600 is extracted from the moving image received by the original time-series data reception module 105 and a wire frame 610 is generated. The wire frame model for detecting the motion of the human is a conventionally known art. As shown in the example of FIG. 6, the components of the body of the human 600 are expressed by an aggregation of the wire frame. In addition, the vector expression of the components of the body is a set of the name of the component of the body, the coordinate of the starting point and the coordinate of the end point such as “neck, (v21, v21), (v22, v22).” For example, a table including a vector ID, the name of the component, date and coordinate of the starting point and date and coordinate of the end point is generated as the vector expression. The preliminarily determined motion is recognized from the change of the vector.

As for the method of analyzing the motion by the motion analysis module 110, a conventional frame analyzer of the human action can be used, for example. As an example, OpenPose and OpenFace developed by CMU (Carnegie Mellon University) can be used. There is a method that analyzes the joint portions by a deep learning from the moving image.

The processing examples processed by the correlation analysis module 115 will be explained using FIG. 7 to FIG. 12D. Note that the explanation will be made using the seminar joined by the teacher 500A and the student 500B as an example.

FIG. 7 is an explanatory drawing showing a processing example of the present embodiment.

An action time-series data 700 shown in the example of FIG. 7 is data column where the action analysis result of the teacher 500A and the student 500B is arranged in time series (time flows from left to right). One frame of the action time-series data 700 indicates one “action” of one object. For example, “1” indicates the action of turning the face to the other person, “2” indicates the action of turning the face to the document, “3” indicates the action of nodding and “4” indicates the action of speaking.

Here, the frame indicates a unit of the motion (action in case of FIG. 7). The rule of generating frames will be explained. The frame is divided (a new frame is generated) each time when the object made a different motion. Even when the object A continues the same motion, when the motion of the object B is changed, not only the frame of the object B but also the frame of the object A is separated. For example, in the action time-series data 700 shown in the example of FIG. 7, although the teacher 500A continues the action 1 (turning the face to the other person), when the action of the student 500B is changed from 2 (turning the face to the document) to 3 (nodding), a new frame of the teacher 500A is also generated at the timing of the change. Accordingly, the frame of the action “2” and the frame of action “3” are generated for the student 500B, while two frames of the action “1” are continuously generated for the teacher 500A.

As for the rule for generating the frames, it is possible to separate the frames when a preliminarily determined time period (e.g., five seconds) has passed even when the action is not changed. Because of this, the fact of continuing the same action can be reflected to the number of the mask patterns.

Here, the time means the period of continuing the action in the frame. In the example of FIG. 7, the first row indicates that the action 1 (turning the face to the other person) of the teacher 500A and the action 2 (turning the face to the document) of the student 500B are performed simultaneously. At the next time period, the second row indicates that the action 1 (turning the face to the other person) of the teacher 500A and the action 3 (nodding) of the student 500B are performed simultaneously.

As understood from the above described rule for generating the frames, the length of each time period is not necessarily same. Specifically, the length of the period of the first row is the length from the student 500B changes the action from 2 (turning the face to the document) to 3 (nodding). The length of the period of the second row is the length from the student 500B changes the action from 3 (nodding) to 2 (turning the face to the document). Thus, the lengths are not necessarily same.

In order to analyze the action and the interaction between two objects, the correlation between the “actions” is accumulated for a predetermined time period.

The types of the correlations are the zero order (single motion), the first order (correlation between two actions) and the second order (correlation in three actions).

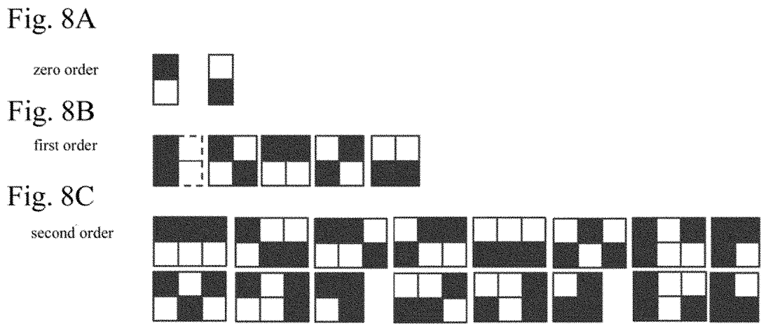

The combination of the actions for obtaining the correlation is in accordance with the mask pattern shown in the example of FIGS. 8A to 8C.

FIGS. 8A to 8C are explanatory drawings showing a processing example of the present embodiment. Examples of correlative mask patterns are shown.

FIG. 8A shows the example of a correlative mask pattern of the zero order. This is the correlative mask pattern selecting one frame from two frames of the same time.

FIG. 8B shows the example of a correlative mask pattern of the first order. This is the correlative mask pattern selecting two frames from four frames at two continuous times.

FIG. 8C shows the example of a correlative mask pattern of the second order. This is the correlative mask pattern selecting three frames from six frames at three continuous times.

The correlative mask pattern of the N order means the pattern selecting (N+1) frames from ((N+1)×number of objects) at (N+1) continuous times. Note that N is an integral of 0 or more. In accordance with the above described definition, the correlative mask pattern of the third or higher order can be generated.

The correlative mask pattern shown in the example of FIG. 8A to 8C indicates that the “actions” corresponding to black frames are extracted, and the “actions” corresponding to white frames is not cared (not selected). Namely, the “actions” corresponding to the white frames can be any actions.

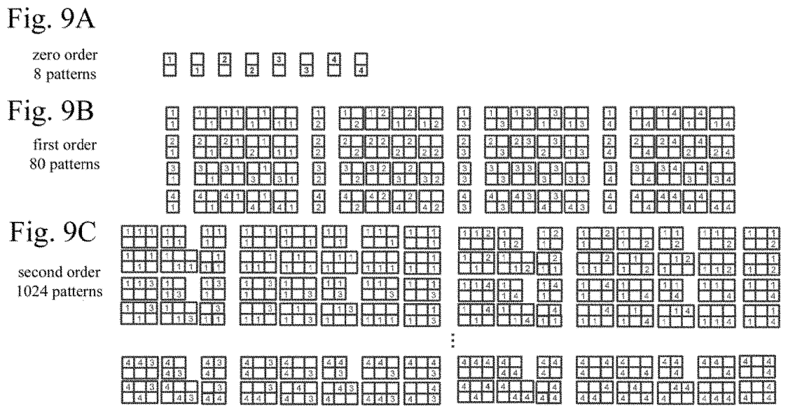

FIGS. 9A to 9C are explanatory drawings showing a processing example of the present embodiment. An example of the correlative mask pattern of four states is shown. For example, the above described four actions (“1”: action of turning the face to the other person, “2”: action of turning the face to the document, “3” action of nodding and “4” action of speaking) are used as four states.

In the correlative mask pattern of M states, M kinds of states (M is the number of kinds of the actions recognizable by each of the motion analysis module 110) are applied to the correlative mask pattern of the N order. Note that M is an integral of 1 or more.

The correlative mask pattern of four states shown in the example of FIGS. 9A to 9C is generated by applying the four states to the black frames of the mask pattern shown in the example shown in FIGS. 8A to 8C.

The correlative mask patterns of four states are totally 1112 patterns. Accordingly, it is characterized in the histogram of 1112 bins.

FIG. 9A shows the example the correlative mask pattern of four states of zero order. There are 8 patterns where the values of 1 to 4 are applied to the black frames of the correlative mask pattern shown in the example of FIG. 8A.

FIG. 9B shows the example the correlative mask pattern of four states of first order. There are 80 patterns where the values of 1 to 4 are applied to the black frames of the correlative mask pattern shown in the example of FIG. 8B.

FIG. 9C shows the example the correlative mask pattern of four states of second order. There are 1024 patterns where the values of 1 to 4 are applied to the black frames of the correlative mask pattern shown in the example of FIG. 8C.

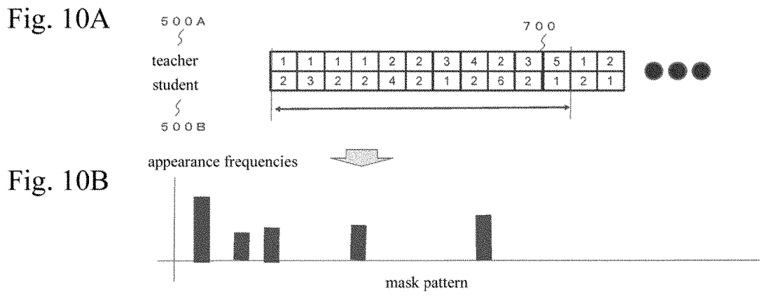

FIGS. 10A and 10B are explanatory drawings showing a processing example of the present embodiment. The processing example of extracting the histogram feature quantity is shown.

(1) The action time-series data is divided in a predetermined period and a part matched with the four states correlative mask pattern is counted. The predetermined period is a preliminarily determined period and defined by the number of the frames.

FIG. 10A shows the example where the action time-series data 700 shown in the example of FIG. 7 is initially divided into 11 frames (totally 22 frames). This means that the initial period of time of the seminar is divided.

(2) The appearance frequencies are arranged for each of the correlative mask pattern of four states to generate the histogram.

FIG. 10B shows the example of the histogram showing an ID of the correlative mask pattern of four states in a horizontal axis and showing the appearance frequency of correlative mask pattern of the four states (the number of times of matching with the correlative mask pattern of four states) in a vertical axis.

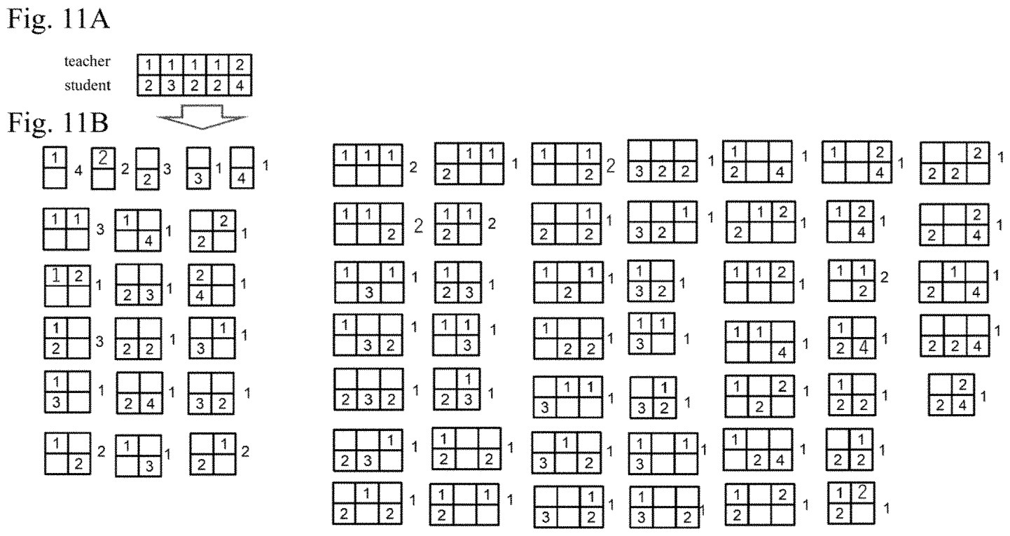

FIGS. 11A and 11B are explanatory drawings showing a processing example of the present embodiment. The extracted example of the feature quantity is shown.

As shown in the example of FIG. 11A, when the feature is extracted from the initial five regions of the action time-series data 700 shown in the example of FIG. 7, the result is shown in the example of FIG. 11B The mask pattern and the appearance frequency of the mask pattern are shown in a pair. In 1112 patterns, 67 patterns appear. Namely, 67 mask patterns have the values as the histogram.

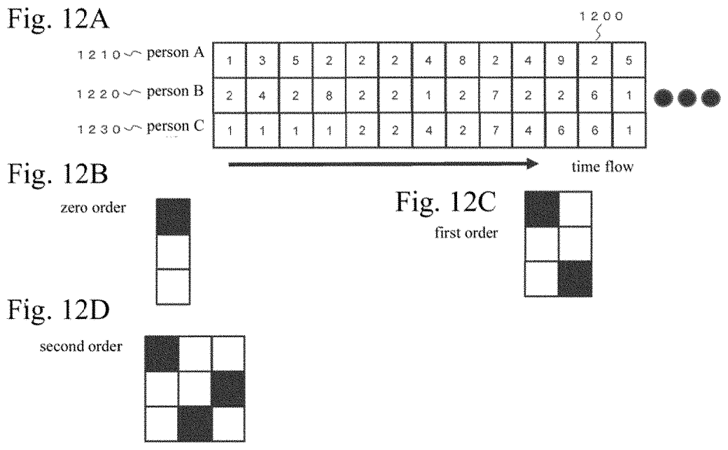

FIGS. 12A to 12D are explanatory drawings showing a processing example of the present embodiment. In the explanation above, the analysis of the correlation of the actions of two objects (teacher 500A, student 500B) is mainly explained. However, it is also possible to analyze the correlation of the actions in three objects.

FIG. 12A shows an example of an action time-series data 1200. FIG. 12A corresponds to the action time-series data 700 shown in the example of FIG. 7 where the actions of three objects (person A1210, person B1220, person C1230) are arranged in time series. Note that FIGS. 12A to 12D are an example having nine types of actions. Namely, the value of any one of 1 to 9 is entered in each frame.

FIG. 12B shows the example of the correlative mask pattern of the zero order. This is an example of the correlative mask pattern where one frame is selected from three frames of the same time.

FIG. 12B shows the example of the correlative mask pattern of the first order. This is an example of the correlative mask pattern where two frames are selected from six frames at two continuous times.

FIG. 12C shows the example of the correlative mask pattern of the second order. This is an example of the correlative mask pattern where three frames are selected from nine frames at three continuous times.

Similarly, it is also possible to analyze the correlation of the actions of four or more objects.

In the present embodiment, the time width of one frame and the number of frames to be calculated are not defined.

HLBC2 is extracted for each of a plurality of time widths and the vector length of the connected feature quantity is long. Thus, both minute motion and time-consuming motion can be extracted.

Although the histogram feature can be extracted as one sequence, it is also possible to extract the histogram feature by dividing into several subsequences and the combining them. Thus, the change of the feature quantity can be seen in time series. For example, when the sequence (one seminar) is divided into four, how the interaction changes can be seen immediately after the seminar is started to the end of the seminar.

In the above described embodiments, the cross-correlation is obtained for a plurality of objects (e.g., two persons of teacher 500A and student 500B), it is also possible to obtain the correlation between different components of the same person. For example, when the cross-correlation is obtained between the motion of the face and the motion of the hand, the gesture and the like can be quantified as the feature quantity.

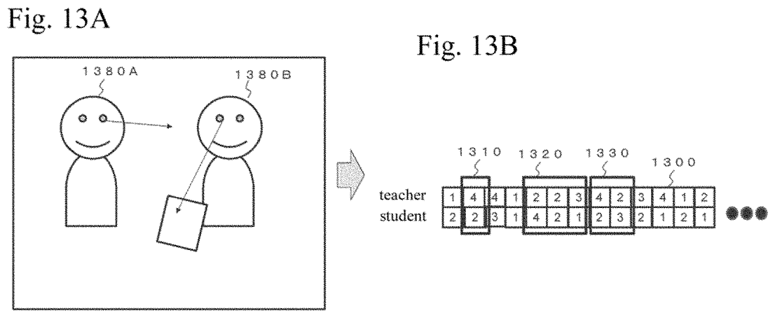

FIGS. 13A and 13B are explanatory drawings showing a processing example of the present embodiment. An example of the interaction analysis in a face-to-face seminar is shown.

FIG. 13A shows the example of the moving image of a teacher 1380A and a student 1380B in the seminar. The teacher 1380A looks at the student 1380B and the student 1380B looks down at the document. For example, “1” indicates the action of turning the face to the other person, “2” indicates the action of turning the face to the document, “3” indicates the action of nodding and “4” indicates the action of speaking.

Accordingly, the example of FIG. 13A is analyzed that the teacher 1380A performs the action “1” and the student 1380B performs the action “2.”

FIG. 13B shows the example of the result of analyzing the moving image of the seminar and generating an action time-series data 1300.

An action group 1310 shows that the student 1380B looks at the document when the teacher 1380A speaks.

An action group 1320 shows that the teacher 1380A looks at the document and nods after the student 1380B speaks.

An action group 1330 shows that the student 1380B nods after the teacher 1380A speaks.

The sequence matched with the mask pattern (shown in FIGS. 9A to 9C) of four states is analyzed by dividing in a certain time zone. For example, the seminar is divided into an initial stage, a middle stage and a final stage and the correlation of the actions of two persons (teacher 1380A, student 1380B) in the seminar can be expressed by the feature quantity extracted by the partial sequence (time zone).

For example, the analysis result is extracted in the following way. In the initial stage of the seminar, the teacher 1380A speaks and the student 1380B looks at the document for a long time. In the middle stage, the teacher 1380A and the student 1380B alternately speak in many times. In the final stage, the teacher 1380A and the student 1380B nod after the other speaks in many times.

An annotation is performed for the time zone of extracting the feature quantity or whole the seminar.

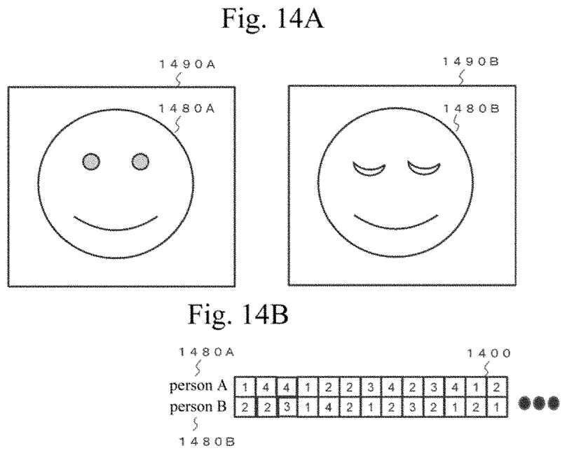

FIGS. 14A and 14B are explanatory drawings showing a processing example of the present embodiment. An example of the interaction analysis in an online seminar is shown.

FIG. 14A shows the example of a moving image (image 1490A) of a teacher 1480A and a moving image (image 1490B) of a student 1480B in the seminar. The moving images are photographed by individual cameras and synchronized with each other by an online meeting system. Thus, an action time-series data 1400 can be generated by analyzing the individual moving image. The teacher 1480A faces the front (i.e., looks at screen and the student 1480B), and the student 1480B looks down at the document. Accordingly, the example of FIG. 14A is analyzed that the teacher 1480A performs the action “1” and the student 1480B performs the action “2.”

FIG. 14B shows the example of the action time-series data 1400 generated by analyzing the moving images. Same as the example of the interaction analysis in the face-to-face seminar shown in the example of FIGS. 13A and 13B, the time-based correlation such as the direction of the face, nodding and speaking can be extracted.

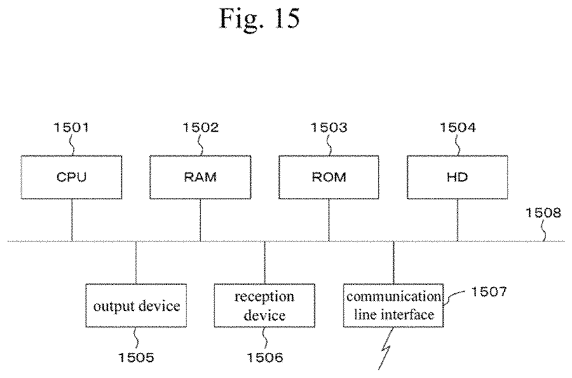

Note that the hardware configuration of the computer in which the program of the present embodiment is executed is a general computer as illustrated in FIG. 15. Specifically, the computer can be a personal computer and a server. Namely, as a specific example, the computer uses a CPU 1501 as a processor (calculator) and a RAM 1502, ROM 1503 and HD 1504 as storage devices. As the HD1504, a hard disk and an SSD (Solid State Drive) can be used, for example. The computer includes a CPU 1501 for executing the programs of the original time-series data reception module 105, the motion analysis module 110, the correlation analysis module 115, the learning module 120 and the like, a RAM 1502 for storing the programs and the data, a ROM 1503 for storing programs and the like for starting the computer, an HD 1504 which is an auxiliary storage devise (e.g., flash memory) for storing the processing result of the module, a reception device 1506 for receiving data based on the operation (including action, sound and sight) of the user operating a keyboard, a mouse, a touch screen, a microphone, a camera (including a moving image photographing camera and a sight detection camera) and the like, an output device 1505 such as a liquid crystal display, an organic EL display, a three dimensional display, a projector and a speaker, a communication line interface 1507 such as a network interface card for connecting with a communication network, and a bus 1508 for connecting the components and transmitting data. A plurality of computers can be connected via a network.

Accordingly, the present embodiment can be grasped as follows.

The information processing device 100 includes a processor and the processor functions as a unit (first analysis unit, second analysis unit, correlation analysis unit) of any one of the invention [1] to the invention [9].

For example, the information processing device 100 includes a processor and the processor functions as a first analysis unit for analyzing the first motion of the first object, a second analysis unit for analyzing the second motion of the second object and a correlation analysis unit for analyzing a time-series correlation between the first motion analyzed by the first analysis unit and the second motion analyzed by the second analysis unit.

In the above described embodiments, the embodiment of the computer program is achieved by making the system having the hardware configuration of the present invention read the computer program which is a software. Thus, the software and the hardware are cooperated with each other.

Note that the hardware configuration shown in FIG. 15 shows one of configuration examples. The embodiment is not limited to the configuration of FIG. 15 as long as the modules explained in the embodiment can be executed. For example, a part of the module can be formed by a dedicated hardware (e.g., Application Specific Integrated Circuit: ASIC), a part of the module can be located in an external system and connected via a communication line, and a plurality of systems shown in FIG. 15 can be connected with each other via a communication line so as to be cooperated with each other. In particular, the module can be incorporated in a personal computer, a portable information communication equipment (including a mobile phone, a smart phone, a mobile device and a wearable computer), an information home appliance and a robot.

In the explanation of the comparison process of the above described embodiment, “or more” “or less” “more than” and “less than” can be replaced to more than” “less than” “or more” and “or less” as long as inconsistency does not occur in the combination.

In the above described embodiment, the processor is a processor in a broad sense and includes a general processor (e.g., CPU: Central Processing Unit) and a dedicated processor (e.g., GPU: Graphics Processing Unit, ASIC, FPGA: Field Programmable Gate Array, programmable logical device).

The operation of the processor in the above described embodiment can be performed by one processor or cooperated by a plurality of processors located physically separate positions. The order of the operations of the processor is not limited to the order described in the above described embodiment. The order can be arbitrarily changed.

Note that the above explained program can be provided in a storage medium and provided by a communication means. In that case, the above explained program can be captured as the invention of “computer readable medium storing the program”, for example.

The “computer readable medium storing the program” is the medium storing the program, readable by the computer and used for installing, executing and distributing the program.

The storage medium includes a digital versatile disk (DVD) such as “DVD-R, DVD-RW, DVD-RAM” and the like which is a format defined by DVD Forum, “DVD+R, DVD+RW” and the like which is a format defined by DVD+RW, a compact disk (CD) such as a read-only memory (CD-ROM), a CD-recordable (CD-R), CD-rewritable (CD-RW) and the like, a Blu-ray (registered trademark) Disc, a magneto-optical disk (MO), a flexible disk (FD), a magnetic tape, a hard disk, a read-only memory (ROM), an electrically erasable programmable read-only memory (EEPROM, registered trade mark), a flash memory, a random access memory (RANI), SD (an abbreviation of Secure Digital) and a memory card, for example.

A part or a whole of the above described program can be stored or distributed while stored in the storage medium. In addition, the program can be transferred by the communication of wired network and wireless network used for a local area network (LAN), a metropolitan area network (MAN), a wide area network (WAN), an internet, an intranet and an extranet, using the transmission medium combining them or on a transmission wave.

Furthermore, the above described program can be a part or a whole of the other program or stored in a recording medium with another program. In addition, the program can be separately stored in a plurality of recording medium. Furthermore, the program can be compressed, encrypted or stored in any forms as long as it can be restored.

### DESCRIPTION OF THE REFERENCE NUMERALS

100 . . . information processing device

105 . . . original time-series data reception module

110 . . . motion analysis module

110A . . . motion analysis A module

110B . . . motion analysis B module

110C . . . motion analysis C module

110D . . . motion analysis D module

115 . . . correlation analysis module

120 . . . learning module

What is claimed is:

1. An information processing device comprising a processor, wherein
the processor is configured to:
analyze a first motion of a first object from a time-series data;
analyze a second motion of a second object from the time-series data; and
analyze a time-series correlation between the analyzed first motion and the analyzed second motion.

2. The information processing device according to claim 1, wherein
one frame is formed by one unit of a motion, and
when the time-series correlation is analyzed, the processor is configured to analyze a correlation between the first motion and the second motion in frames neighboring to each other in time series.

3. The information processing device according to claim 2, wherein
when the time-series correlation is analyzed, the processor is configured to further analyze the correlation between the first motion and the second motion in one frame simultaneously performed.

4. The information processing device according to claim 3, wherein
when the time-series correlation is analyzed, the processor is configured to analyze the time-series correlation by counting a part matched with a mask pattern formed by one frame.

5. The information processing device according to claim 2, wherein
when the time-series correlation is analyzed, the processor is configured to analyze the time-series correlation between the first motion and the second motion performed in continuous frames.

6. The information processing device according to claim 5, wherein
when the time-series correlation is analyzed, the processor is configured to analyze the time-series correlation by counting a part matched with a mask pattern formed by two or more continuous frames.

7. The information processing device according to claim 4, wherein
when the time-series correlation is analyzed, the processor is configured to analyze the time-series correlation by generating a histogram from a counting result obtained by counting the part matched with the mask pattern.

8. The information processing device according to claim 7, wherein
the processor is configured to perform a mechanical leaning using the histogram as a teacher data of the mechanical leaning.

9. A non-transitory computer readable medium storing an information processing program for making a computer function as:
a first analysis unit configured to analyze a first motion of a first object from a time-series data;
a second analysis unit configured to analyze a second motion of a second object from the time-series data; and
a correlation analysis unit configured to analyze a time-series correlation between the first motion analyzed by the first analysis unit and the second motion analyzed by the second analysis unit.

10. An information processing method performed by an information processing device, the method comprising:
a first step for analyzing a first motion of a first object from a time-series data;
a second step for analyzing a second motion of a second object from the time-series data; and
a third step of analyzing a time-series correlation between the first motion analyzed in the first step and the second motion analyzed in the second step.
